(19) United States
(12) Patent Application Publication
(10) Pub. No.: US 2026/0330443 A1
(43) Pub. Date: Oct. 22, 2026

(54) KIOSK-BASED PRINTING SYSTEM FOR CUSTOMIZED GREETING CARDS AND GIFT CARDS

(71) Applicant: James Curtis, Carrollton, TX (US)

(72) Inventor: James Curtis, Carrollton, TX (US)

(21) Appl. No.: 19/634,756

(22) Filed: Mar. 31, 2026

Related U.S. Application Data
(63) Continuation of application No. 18/922,229, filed on Oct. 21, 2024.
Application No. 18/922,229 is a continuation-in-part of application No. 18/377,193, filed on Oct. 5, 2023, now Pat. No. 12,125,807.
Application No. 18/377,193 is a continuation-in-part of application No. 18/010,728, filed on Jul. 8, 2021, now Pat. No. 11,967,215.
Application No. 18/010,728 is a continuation-in-part of application No. 16/925,144, filed on Jul. 9, 2020, now Pat. No. 10,846,684.
Application No. 16/925,144 is a continuation-in-part of application No. 16/792,735, filed on Feb. 17, 2020, now Pat. No. 11,379,810.
Application No. 16/792,735 is a continuation-in-part of application No. 16/667,088, filed on Oct. 29, 2019, now abandoned.
Application No. 16/667,088 is a continuation of application No. 15/359,447, filed on Nov. 22, 2016, now Pat. No. 9,679,287.
Application No. 15/359,447 is a continuation of application No. 14/697,318, filed on Apr. 27, 2015, now Pat. No. 9,508,064.
Application No. 14/697,318 is a continuation of application No. 14/596,990, filed on Jan. 14, 2015, now Pat. No. 10,460,311.
Application No. 14/596,990 is a continuation-in-part of application No. 13/108,837, filed on May 16, 2011, now abandoned.
Application No. 13/108,837 is a continuation-in-part of application No. 12/839,294, filed on Jul. 19, 2010, now abandoned.
Application No. 12/839,294 is a continuation-in-part of application No. 12/505,342, filed on Jul. 17, 2009, now abandoned.
(60) Provisional application No. 63/573,279, filed on Apr. 2, 2024.

(51) Int. Cl. G06Q 20/34; G06Q 20/40

(52) U.S. Cl. CPC G06Q 20/348; G06Q 20/4012

(57) ABSTRACT

A kiosk-based printing system includes a printer configured to perform a dye-sublimation thermal transfer process. The printer is configured to print on a laminated paper stock comprising a white paper core with a polymer gloss coating. The printer is further configured to print on PVC gift card blanks. The kiosk-based printing system includes a hopper configured to hold a plurality of blank PVC gift cards. The kiosk-based printing system includes a communication interface configured to communicate over a secure network with gift card issuers to obtain gift card activation data including gift card numbers and PINs. The kiosk-based printing system is configured to encode the gift card activation data onto a magnetic stripe or an NFC chip of a gift card blank.

### RELATED APPLICATIONS

This disclosure is a continuation-in-part of U.S. application Ser. No. 18/922,229, filed Oct. 21, 2024, which claims priority to U.S. Provisional application Ser. No. 63/573,279, filed Apr. 2, 2024, and is also a continuation-in-part of U.S. application Ser. No. 18/377,193, filed Oct. 5, 2023, now U.S. Pat. No. 12,125,807, which is a continuation-in-part of U.S. application Ser. No. 18/010,728, filed Dec. 15, 2022, now U.S. Pat. No. 11,967,215, which is a national stage filing from international application No. PCT/2021/040840, filed Jul. 8, 2021, which claims priority to U.S. application Ser. No. 16/925,144, filed Jul. 9, 2020, now U.S. Pat. No. 10,846,684, which is a continuation-in-part of U.S. application Ser. No. 16/792,735, filed Feb. 17, 2020, now U.S. Pat. No. 11,379,810, which is a continuation-in-part of U.S. application Ser. No. 16/667,088, filed Oct. 29, 2019, now abandoned, which is a continuation of U.S. application Ser. No. 15/359,447, filed Nov. 22, 2016, now U.S. Pat. No. 9,679,287, which is a continuation of U.S. application Ser. No. 14/697,318, filed Apr. 27, 2015, now U.S. Pat. No. 9,508,064, which is a continuation of U.S. application Ser. No. 14/596,990, filed Jan. 14, 2015, now U.S. Pat. No. 10,460,311, which is a continuation-in-part of U.S. application Ser. No. 13/108,837, filed May 16, 2011, now abandoned, which is a continuation-in-part of U.S. application Ser. No. 12/839,294, filed Jul. 19, 2010, now abandoned, which is a continuation-in-part of U.S. application Ser. No. 12/505,342, filed Jul. 17, 2009, now abandoned. All of these disclosures are incorporated herein by reference in their entireties for all purposes.

### TECHNICAL FIELD

The present disclosure relates to kiosk-based printing systems, and more particularly to a kiosk-based printing system employing dye-sublimation thermal transfer processes for printing customized greeting cards and gift cards, along with methods for on-demand activation of gift cards.

### BACKGROUND

Greeting cards have traditionally been fabricated from cardstock or heavy paperboard, with materials ranging from wood-pulp-based paper to recycled fibers and specialty options including matte, glossy, or pearlescent finishes. Conventional printing techniques for greeting cards include sheet-fed offset lithography for mass production, which utilizes the principle that oil and water do not mix to transfer ink from metal plates to a rubber blanket and onto the paper. Digital printing technologies, including inkjet and laser methods, are also employed for short-run or personalized cards. To enhance visual appeal, greeting cards may undergo secondary processes such as foil stamping, UV coating, embossing, or die-cutting.

Gift cards have conventionally been manufactured from polyvinyl chloride (PVC) or polyvinyl chloride acetate (PVCA) materials, which provide rigidity and durability for long-term use. As alternatives, high-density paperboard or specialized cellulose substrates with multi-layer construction have been adopted to approximate the thickness of plastic cards. Conventional printing techniques for gift cards include offset lithography for high-volume production and digital printing for short-run or personalized cards with variable data such as serial numbers or custom imagery. Gift cards typically receive protective treatments such as UV coating or lamination to prevent scratching. Standard gift cards incorporate data carriers such as magnetic stripes, barcodes, or QR codes for activation and transaction processing.

Existing approaches to greeting card and gift card production face various challenges. Specialty papers for greeting cards can be cost-prohibitive, and certain oil-based inks may present environmental sustainability concerns. Structural versatility for modern interactive features can be limited. These challenges can be exacerbated when greeting cards are customized and printed on demand in real-time. Similarly, the printing techniques conventionally employed for manufacturing greeting cards and gift cards have their own limitations, particularly in on-demand real-time printing scenarios.

A further challenge in the field relates to the ability of a single printing system to print both greeting cards and gift cards when these card types are comprised of differing materials. Duplex printing capabilities for on-demand customized greeting cards and gift cards, combined with the ability to activate gift cards on demand in real time, present additional technical considerations. Accordingly, there remains room for improvement in kiosk-based printing systems and methods for producing customized greeting cards and gift cards.

A further challenge in the field relates to the availability of printing systems capable of producing both greeting cards and gift cards from a single printing unit. Currently, there may be no all-in-one dye-sublimation thermal transfer printer in the marketplace that delivers both greeting cards with integrated gift cards, or stand-alone greeting cards and stand-alone gift cards on both paper and PVC substrates. Existing solutions may require multiple printer engines, such as one printer for paper substrates and a separate printer for plastic substrates, which may increase the overall system footprint and introduce additional failure points. The development of a single hardware system capable of handling disparate substrates, including standard cardstock for greeting cards and PVC for gift cards, via a unified dye-sublimation process presents technical considerations that have not been fully addressed by conventional printing systems.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a kiosk-based printing system is provided. The kiosk-based printing system includes a printer configured to perform a dye-sublimation thermal transfer process. The printer is configured to print on a laminated paper stock comprising a white paper core with a polymer gloss coating. The printer is further configured to print on PVC gift card blanks. The kiosk-based printing system includes a hopper configured to hold a plurality of blank PVC gift cards. The kiosk-based printing system includes a communication interface configured to communicate over a secure network with gift card issuers to obtain gift card activation data including gift card numbers and PINs, in order to encode the gift cards and thereby activate the gift cards on demand locally. The kiosk-based printing system is configured to encode the gift card activation data onto magnetic stripes or NFC chips of gift card blanks.

According to other aspects of the present disclosure, the kiosk-based printing system may include one or more of the following features. The laminated paper stock may be provided as roll stock. The laminated paper stock may have a paper weight of approximately 67/157 gsm. The laminated paper stock may include pre-formed die-cut features including gift card slots, tongue tabs, and slots for receiving tongue tabs. The laminated paper stock may include micro-perforations or scoring around an integrated gift card area. The printer may be configured to print in full color on one or both sides of the laminated paper stock. The printer may be configured to print greeting cards having dimensions of approximately 4 inches by 6 inches. The printer may be configured to print gift cards having dimensions of approximately 2.13 inches by 3.38 inches. The hopper may have a capacity of approximately 2,000 blank PVC gift cards. The printer may be configured to complete printing of a customized greeting card, a customized gift card, or both integrated in a single paper stock in approximately 15 seconds. The printer may include ribbon cartridges having a capacity of 500 or more 4 inch by 6 inch prints.

According to another aspect of the present disclosure, a laminated paper stock for on-demand printing of greeting cards and gift cards is provided. The laminated paper stock includes a white paper core. The laminated paper stock includes a polymer gloss coating formed over the white paper core. The laminated paper stock is configured to receive dye-sublimation thermal transfer printing wherein dye is vaporized and infused into the white paper core under the polymer gloss coating.

According to other aspects of the present disclosure, the laminated paper stock may include one or more of the following features. The polymer gloss coating may comprise polyester. The laminated paper stock may be provided as roll stock. The laminated paper stock may have a paper weight of approximately 67/157 gsm. The laminated paper stock may include pre-formed gift card slots configured to hold a PVC gift card. The laminated paper stock may include a tongue tab formed as a semi-circular perforated flap proximate a bottom edge. The laminated paper stock may include a slot formed proximate a top edge configured to receive the tongue tab when the laminated paper stock is folded. The laminated paper stock may include a perforated perimeter defining an integrated gift card area configured to be separated from a greeting card portion. The laminated paper stock may include a fold line extending horizontally across the laminated paper stock. The laminated paper stock may include a perforated line adjacent to the fold line for separating a greeting card portion from a gift card portion.

According to another aspect of the present disclosure, a method for on-demand printing and activation of customized greeting cards and gift cards is provided. The method includes receiving user input specifying customization for a greeting card and a gift card. The method includes printing the customized greeting card on a laminated paper stock using a dye-sublimation thermal transfer process. The dye-sublimation thermal transfer process includes applying heat via a thermal printhead to a ribbon to vaporize ink. The vaporized ink penetrates the laminated paper stock surface and returns to a solid state to become an integral part of the laminated paper stock. The method includes communicating over a secure network with a gift card issuer to obtain gift card activation data. The method includes encoding the gift card activation data onto the gift card.

According to other aspects of the present disclosure, the method may include one or more of the following features. Encoding the gift card activation data may include printing a bar code on an integrated gift card portion of the laminated paper stock. Encoding the gift card activation data may include printing a QR code on an integrated gift card portion of the laminated paper stock. Encoding the gift card activation data may include printing a gift card number and PIN on an integrated gift card portion of the laminated paper stock, or on a PVC gift card blank. Encoding the gift card activation data may include writing to a magnetic stripe on a PVC gift card blank. Encoding the gift card activation data may include writing to an NFC/EMV chip on a gift card blank. The method may include printing the customized gift card on a PVC gift card blank using the dye-sublimation thermal transfer process. The method may include printing on both a front side and a back side of the laminated paper stock. The method may include printing on both a front side and a back side of a PVC gift card blank. The method may include printing instructions for redeeming the gift card on the laminated paper stock.

According to another aspect of the present disclosure, a customizable greeting card is provided. The customizable greeting card includes a greeting card stock comprising laminated paper stock having a white paper core with a polymer gloss coating. The greeting card stock has dimensions of approximately 4 inches by 6 inches. The customizable greeting card includes a greeting card print area on an upper portion of the greeting card stock. The customizable greeting card includes a fold line extending horizontally across the greeting card stock. The customizable greeting card includes a tongue tab formed proximate a bottom edge of the greeting card stock. The customizable greeting card includes a slot formed proximate a top edge of the greeting card stock configured to receive the tongue tab when the greeting card stock is folded along the fold line.

According to other aspects of the present disclosure, the customizable greeting card may include one or more of the following features. The customizable greeting card may include gift card slots configured to hold a PVC gift card. The customizable greeting card may include a perforated line adjacent to the fold line for separating a greeting card portion from a gift card portion. The customizable greeting card may include an integrated paper gift card surrounded by a perforated perimeter enabling separation from the greeting card stock. The integrated paper gift card may have dimensions of approximately 2 inches by 3 inches, and more specifically, industry CR80 size specifications. The integrated paper gift card may include a magnetic stripe. The integrated paper gift card may include an NFC/EMV chip. The customizable greeting card may include a printed bar code on the integrated paper gift card for gift card activation. The customizable greeting card may include a printed gift card number and PIN on the integrated paper gift card for gift card activation. The customizable greeting card may include printed instructions for redeeming the gift card.

According to another aspect of the present disclosure, an all-in-one dye-sublimation printer is provided. The all-in-one dye-sublimation printer includes a unified thermal transfer printing engine having a common thermal print head configured to selectively deposit pigment onto a plurality of disparate substrates. The common thermal print head is configured to interface with both porous substrates comprising paper and greeting card stock and non-porous substrates comprising plastic materials. The all-in-one dye-sublimation printer includes a media transport system configured to feed the plurality of disparate substrates through a printing path to the common thermal print head. The all-in-one dye-sublimation printer includes a ribbon containing panels of cyan, magenta, yellow, and a clear overcoat, wherein the common thermal print head applies heat to the ribbon to vaporize dye that bonds with the substrates.

According to other aspects of the present disclosure, the all-in-one dye-sublimation printer may include one or more of the following features. The non-porous substrates may comprise PVC gift card blanks having a CR80 form factor of approximately 3.375 inches by 2.125 inches. The porous substrates may comprise laminated paper stock having a white paper core with a polymer gloss coating. The polymer gloss coating may comprise polyester. Also, stock with a paper substrate coated with acrylic or PVC may also be employed. This is a first-time thing to print on this type of substates for greeting cards and gift cards (has been done for photos).

The all-in-one dye-sublimation printer may be configured to complete printing of a customized greeting card, a customized gift card, or both in approximately 8.3 seconds. The all-in-one dye-sublimation printer may include automatic laminating technology configured to provide water resistant, dustproof, and oxidation-resistant protection for printed substrates. The all-in-one dye-sublimation printer may include a cooling system configured to dissipate heat generated by the common thermal print head to prevent bonding issues or degradation of print quality. The common thermal print head may be configured for precision ink placement by depositing dye onto the substrates with mechanical and electronic components coordination. The all-in-one dye-sublimation printer may be configured to print both paper cardstock greeting cards and PVC gift cards from a single printing unit. The all-in-one dye-sublimation printer may include an interactive display and a keypad positioned on a housing for user interface. The all-in-one dye-sublimation printer may include a plurality of blank PVC gift card stock bank holders configured to hold stacks of blank PVC gift cards. The all-in-one dye-sublimation printer may include a communication interface configured to communicate over a secure network with gift card issuers to obtain gift card activation data. The all-in-one dye-sublimation printer may include an encoder configured to encode the gift card activation data onto a magnetic stripe or an NFC chip of a PVC gift card blank. The porous substrates may be provided as roll stock, and the all-in-one dye-sublimation printer may include a cutter configured to cut printed greeting cards from the roll stock. The all-in-one dye-sublimation printer may be configured to print on both a front side and a back side of the substrates.

According to another aspect of the present disclosure, a method of printing customized greeting cards and gift cards using an all-in-one dye-sublimation printer is provided. The method includes receiving a first substrate comprising a porous material at a common thermal print head of the all-in-one dye-sublimation printer. The method includes applying heat via the common thermal print head to a ribbon to vaporize dye, wherein the vaporized dye bonds with the first substrate to print a customized greeting card. The method includes receiving a second substrate comprising a non-porous plastic material at the common thermal print head. The method includes applying heat via the common thermal print head to the ribbon to vaporize dye, wherein the vaporized dye bonds with the second substrate to print a customized gift card.

According to other aspects of the present disclosure, the method may include one or more of the following features. The first substrate may comprise laminated paper stock having a white paper core with a polymer gloss coating, and the second substrate may comprise a CR80 form factor PVC gift card blank. Printing the customized greeting card and printing the customized gift card may be completed within a single user session. The method may include communicating over a secure network with a gift card issuer to obtain gift card activation data, and encoding the gift card activation data onto the customized gift card. Encoding the gift card activation data may comprise writing to a magnetic stripe or an NFC chip on the second substrate. Printing the customized greeting card and printing the customized gift card may each be completed in approximately 8.3 seconds. The method may include applying an automatic laminating treatment to the customized greeting card and the customized gift card to provide water resistant, dustproof, and oxidation-resistant protection. The method may include dissipating heat generated by the common thermal print head using a cooling system to prevent bonding issues or degradation of print quality.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates an orthogonal view of a customizable greeting card configured to hold a PVC gift card, according to aspects of the present disclosure.

FIG. 2 illustrates an orthogonal view of a customizable greeting card with an integrated paper gift card, according to aspects of the present disclosure.

FIG. 3 illustrates an isometric view of a greeting card paper stock roll, according to aspects of the present disclosure.

FIG. 4 illustrates orthogonal views of paper and PVC gift card blanks, according to aspects of the present disclosure.

FIG. 5 illustrates a perspective view of a custom printed greeting card with an integrated gift card, according to aspects of the present disclosure.

FIG. 6 illustrates an orthogonal view of a custom printed greeting card with an integrated gift card, according to aspects of the present disclosure.

FIG. 7 illustrates an orthogonal view of another embodiment of a customized greeting card configured to hold a PVC gift card, according to aspects of the present disclosure.

FIG. 8 illustrates a perspective view of a custom printed greeting card configured to hold a PVC gift card, according to aspects of the present disclosure.

FIG. 9 illustrates an isometric view of another embodiment of a greeting card paper stock roll, according to aspects of the present disclosure.

FIG. 10 illustrates an isometric view of a stand-alone all-in-one printer configured to print customized greeting cards and integrated gift cards on paper card stock, and separate customized greeting cards on paper card stock and separate PVC gift cards, according to aspects of the present disclosure.

FIG. 11 illustrates an isometric view of the internal components of an all-in-one printer, according to aspects of the present disclosure.

FIG. 12 illustrates a conceptual view of an all-in-one printer during a dye sublimation printing process, according to aspects of the present disclosure.

FIG. 13 illustrates another conceptual view of an all-in-one printer during a dye sublimation printing process, according to aspects of the present disclosure.

FIG. 14 illustrates an isometric view of a wireframe model of a dye sublimation printer according to aspects of the present disclosure.

FIG. 15 illustrates an isometric view of a greeting card and gift card kiosk having a dye sublimation printer according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Kiosk-based printing systems in accordance with the disclosed principles provide for user-customized printing of both greeting cards and gift cards on demand. The dual creation of on demand customizable greeting cards and gift cards is also disclosed in copending U.S. patent application Ser. No. 19/207,883, patent publication US 2025/0272672, the entirety of which is incorporated herein by reference for all purposes. However, in accordance with the disclosed principles, disclosed kiosk-based systems may be configured to perform duplex printing processes that accommodate different substrate materials, including laminated paper stock and plastic gift card blanks such as those constructed from polyvinyl chloride (PVC) or similar materials with the same printing head or system. The dual printing capability of these systems enables a single kiosk to produce customized greeting cards on laminated paper stock while also producing customized gift cards on rigid PVC card blanks, or alternatively, to produce combined greeting cards with integrated gift cards on a single piece of laminated paper stock.

Kiosk-based printing systems as disclosed herein may employ a dye-sublimation thermal transfer printing process to achieve high-quality image reproduction on both laminated paper stock and PVC gift card substrates. The dye-sublimation process may infuse ink into the substrate material rather than depositing ink on the surface, which may result in images that resist smudging, smearing, cracking, peeling, or fading. The printing systems may be configured to print in full color or black and white on one or both sides of the substrate material, providing flexibility in the customization of greeting cards and gift cards.

In addition to printing capabilities, kiosk-based systems in accordance with the disclosed principles may be configured to activate gift cards in real time. Gift card activation may be accomplished through communication over a secure network with gift card issuers to obtain unique gift card numbers and personal identification numbers (PINs). Specifically, kiosks as disclosed herein employ the applicant's proprietary “Incompass Retail” software (disclosed in copending U.S. patent application Ser. No. 18/922,229, patent publication US 2025/0045727) that enables on demand activation of gift cards through communication over a secure network with gift card issuers to obtain unique gift card number and PINs to encode onto, and thereby activate, the customized gift cards. The entirety of application Ser. No. 18/922,229 is incorporated herein by reference for all purposes. The kiosk-based systems may encode activation data onto gift cards using various methods, including printing bar codes, quick response (QR) codes, or alphanumeric codes onto the gift card surface, or writing data to magnetic stripes or near-field communication (NFC) chips incorporated into gift card blanks. This on-demand activation capability enables the creation of fully functional gift cards at the point of sale without requiring pre-activated card inventory.

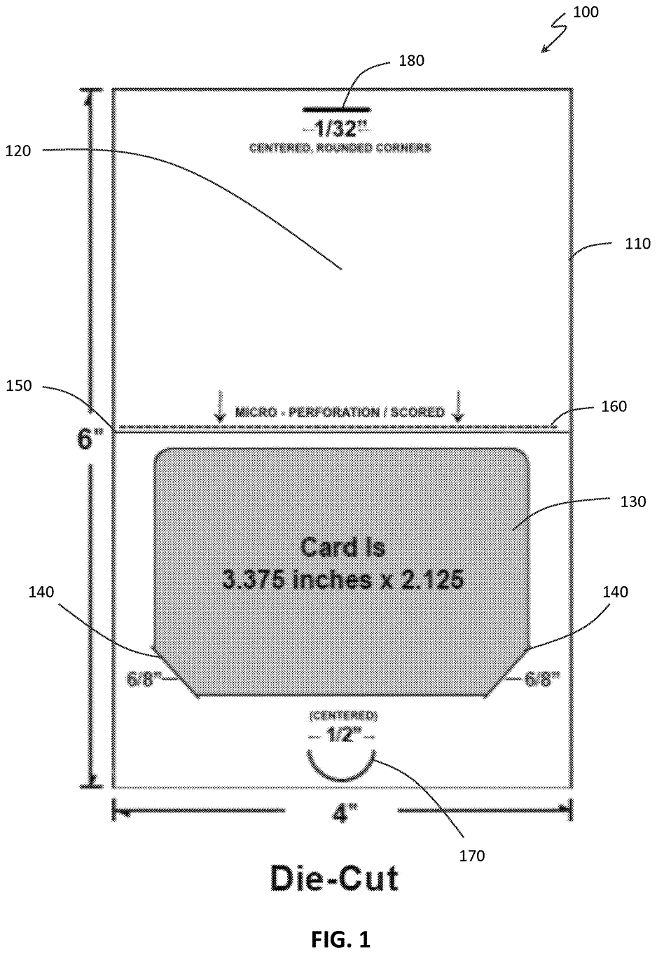

Referring to FIG. 1, a customizable greeting card 100 is configured to hold a PVC gift card 130. The customizable greeting card 100 is formed from a greeting card stock 110, which comprises a laminated paper stock. The greeting card stock 110 may comprise a white paper core with a polymer gloss coating formed over the white paper core. In some cases, the polymer coating on the greeting card stock 110 is a polyester coating. In other embodiments, the substrates for the greeting card stock 110 may comprise laminated paper stock coated with acrylic or PVC. The greeting card stock 110 may have a paper weight of about 67/157 gsm, similar to photo paper. The customizable greeting card 100 may have dimensions of approximately 4 inches by 6 inches.

The customizable greeting card 100 includes a greeting card print area 120 positioned in an upper portion of the greeting card stock 110. The greeting card print area 120 provides a surface for receiving custom printed images, text, or other visual content through the dye-sublimation thermal transfer printing process. The greeting card print area 120 may feature rounded corners.

With continued reference to FIG. 1, the customizable greeting card 100 includes gift card slots 140 formed in the greeting card stock 110. The gift card slots 140 are configured to receive and hold the PVC gift card 130 within the customizable greeting card 100. The gift card slots 140 may be positioned on opposing sides of a gift card receiving area in a lower portion of the customizable greeting card 100. The PVC gift card 130 may be inserted into the gift card slots 140 such that the PVC gift card 130 is secured within the customizable greeting card 100.

A fold line 150 extends horizontally across the greeting card stock 110, dividing the customizable greeting card 100 into upper and lower portions. A perforated line 160 is positioned adjacent to the fold line 150. The perforated line 160 may be micro-perforated or scored to facilitate separation between a greeting card portion and a gift card portion of the customizable greeting card 100.

As further shown in FIG. 1, the customizable greeting card 100 includes a fold and lock closure system. A tongue tab 170 is formed as a semi-circular perforated flap proximate a bottom edge of the greeting card stock 110. A slot 180 is formed proximate to a top edge of the greeting card stock 110. The slot 180 is configured to receive the tongue tab 170. When the customizable greeting card 100 is folded along the fold line 150, the tongue tab 170 engages with the slot 180 to provide a closure mechanism that holds the customizable greeting card 100 in a folded position. The fold and lock closure system enables the customizable greeting card 100 to securely hold the PVC gift card 130 within the folded greeting card. In some cases, the customizable greeting card 100 may be folded to hold other items such as checks or cash for an intended recipient.

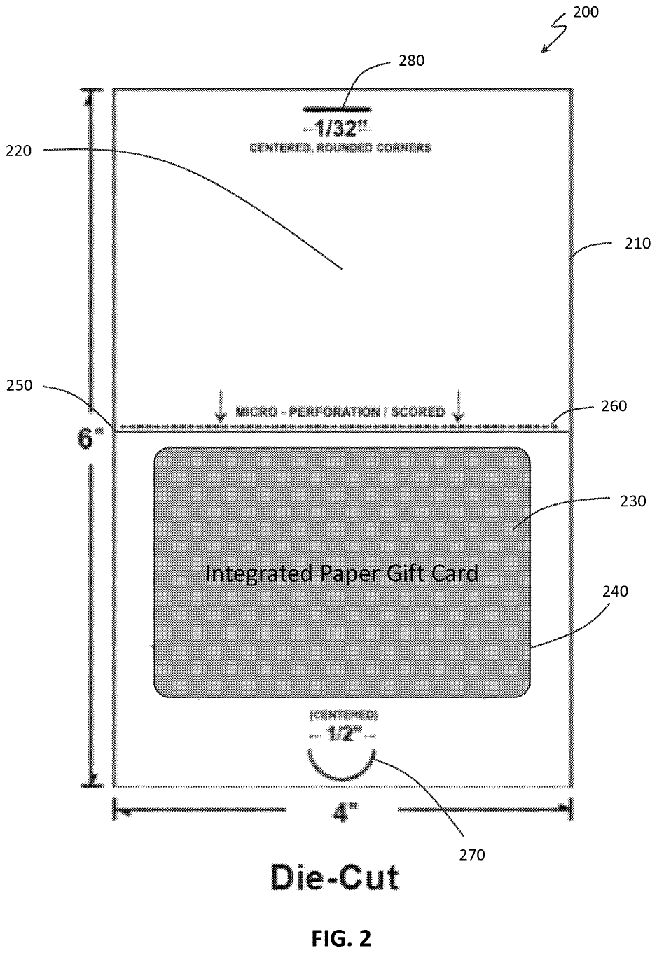

Referring to FIG. 2, a customizable greeting card 200 is configured with an integrated paper gift card 230. The customizable greeting card 200 comprises a greeting card stock 210, which serves as the substrate material for the card construction. The greeting card stock 210 may comprise laminated paper stock having a white paper core with a polymer gloss coating formed over the white paper core. The greeting card stock 210 may have dimensions of approximately 4 inches in width and 6 inches in height.

The customizable greeting card 200 includes a greeting card print area 220 positioned in an upper portion of the greeting card stock 210. The greeting card print area 220 provides a surface for custom printing of images, text, or other visual content through the dye-sublimation thermal transfer printing process. The greeting card print area 220 may feature rounded corners.

With continued reference to FIG. 2, the customizable greeting card 200 includes the integrated paper gift card 230 positioned in a lower portion of the greeting card stock 210. The integrated paper gift card 230 may have a size of about 2 inches by 3 inches. The integrated paper gift card 230 is surrounded by a perforated perimeter 240. The perforated perimeter 240 enables the integrated paper gift card 230 to be punched out or separated from the greeting card stock 210 for independent use. The perforated perimeter 240 around the integrated paper gift card 230 allows the integrated paper gift card 230 to be separated from the customizable greeting card 200 and carried like a typical gift card. The integrated paper gift card 230 may feature rounded corners.

A fold line 250 extends horizontally across the greeting card stock 210, dividing the customizable greeting card 200 into upper and lower sections. A perforated line 260 is positioned adjacent to the fold line 250. The perforated line 260 may be micro-perforated or scored to facilitate separation of the greeting card portion from the gift card portion.

As further shown in FIG. 2, the customizable greeting card 200 includes a fold and lock closure system. A tongue tab 270 is formed proximate a bottom edge of the greeting card stock 210. The tongue tab 270 may be centered on the bottom edge with a width of approximately ½ inch. A slot 280 is positioned proximate a top edge of the greeting card stock 210. The slot 280 is configured to receive the tongue tab 270. When the customizable greeting card 200 is folded along the fold line 250, the tongue tab 270 can be inserted into the slot 280 to secure the customizable greeting card 200 in a folded configuration. The fold and lock closure system of the customizable greeting card 200 functions similarly to the closure system described with reference to FIG. 1.

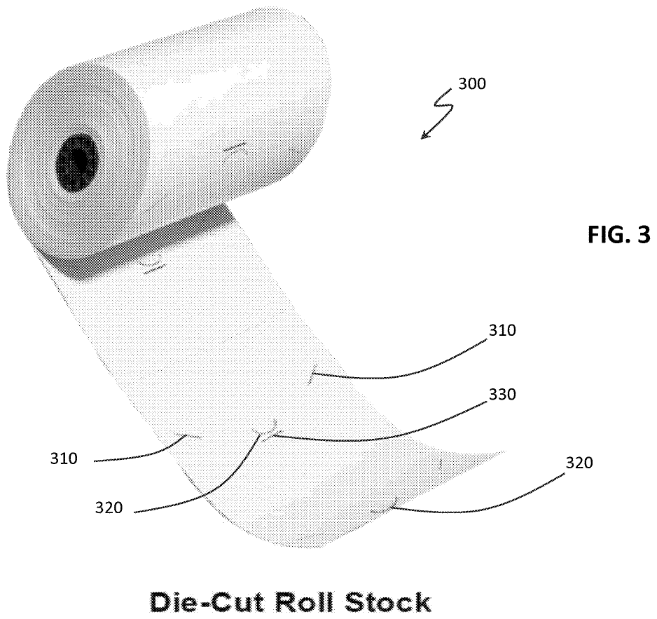

Referring to FIG. 3, a greeting card paper stock roll 300 comprises a roll of laminated paper stock configured for use in on-demand printing of customized greeting cards and gift cards. The greeting card paper stock roll 300 provides the greeting card stock in a roll stock paper format, which may facilitate efficient feeding of the laminated paper stock through kiosk-based printing systems. The laminated paper stock of the greeting card paper stock roll 300 may comprise a white paper core with a, acrylic, PVC, polyester or other polymer gloss coating formed over the white paper core, similar to the greeting card stock 110 and the greeting card stock 210 described with reference to FIGS. 1 and 2.

The greeting card paper stock roll 300 includes pre-formed die-cut features that are formed into the laminated paper stock prior to printing. A gift card slot 310 is formed on the laminated paper stock of the greeting card paper stock roll 300. The gift card slot 310 is configured to receive and hold a physical gift card, such as the PVC gift card 130 described with reference to FIG. 1, within a printed greeting card. As shown in FIG. 3, multiple instances of the gift card slot 310 may be visible on an unrolled portion of the greeting card paper stock roll 300, corresponding to individual greeting card blanks on the roll stock.

With continued reference to FIG. 3, a tongue tab 320 is formed on the laminated paper stock of the greeting card paper stock roll 300. The tongue tab 320 appears as a semi-circular flap that is perforated into the laminated paper stock. A slot 330 is also formed on the laminated paper stock of the greeting card paper stock roll 300. The slot 330 is configured to receive the tongue tab 320 when a printed greeting card is folded along a fold line, thereby holding the greeting card in a folded position. The tongue tab 320 and the slot 330 function as a fold and lock closure system similar to the tongue tab 170 and the slot 180 described with reference to FIG. 1, and the tongue tab 270 and the slot 280 described with reference to FIG. 2.

The greeting card paper stock roll 300 includes pre-formed micro-perforations and die-cuts for the physical gift card and closure. The pre-formed micro-perforations and die-cuts on the greeting card paper stock roll 300 may include the gift card slot 310, the tongue tab 320, and the slot 330. The roll stock format with pre-formed micro-perforations and die-cuts facilitates efficient on-demand printing of customized greeting cards by eliminating the need for post-printing cutting or perforation operations. The pre-formed features on the greeting card paper stock roll 300 enable the production of greeting cards with integrated closure mechanisms and gift card holding capabilities in a single printing operation.

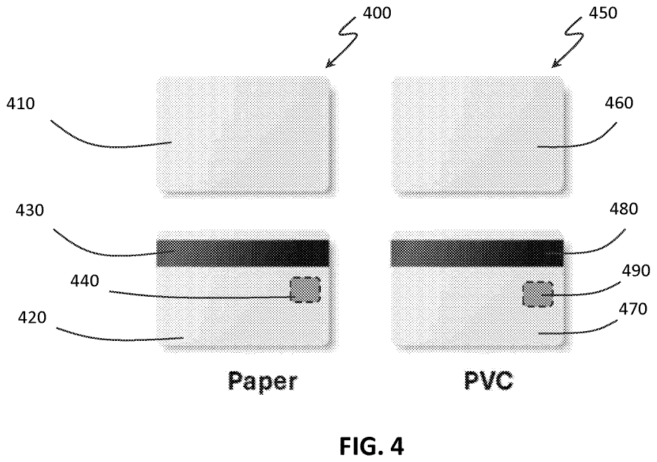

Referring to FIG. 4, a paper gift card 400 and a PVC gift card 450 are illustrated as gift card blanks that are customizable and activatable in accordance with the disclosed principles. The paper gift card 400 and the PVC gift card 450 may each be configured to receive custom printing through the dye-sublimation thermal transfer printing process and may be encoded with activation data for on-demand gift card activation.

The paper gift card 400 includes a gift card front 410 that serves as a printing area for customization. The gift card front 410 provides a surface for receiving custom printed images, text, logos, or other visual content. A gift card back 420 is positioned on an opposite side of the paper gift card 400 from the gift card front 410. The gift card back 420 provides an optional printing area that may receive additional printed content such as terms and conditions, redemption instructions, or decorative elements.

With continued reference to FIG. 4, the paper gift card 400 includes a magstripe 430 positioned on the gift card back 420. The magstripe 430 may be a 3-track magnetic stripe configured to store encoded data for gift card activation and transaction processing. The magstripe 430 may be positioned horizontally across an upper portion of the gift card back 420. An NFC chip 440 may be provided on the paper gift card 400 as an alternative to the magstripe 430. The NFC chip 440 enables contactless communication for gift card activation and redemption. In some cases, the paper gift card 400 may include the magstripe 430 without the NFC chip 440, or the paper gift card 400 may include the NFC chip 440 without the magstripe 430.

The paper gift card 400 may be constructed as three ply 28 pt 675 GSM with polyester/polymer gloss coating bleach white paper. The three-ply construction of the paper gift card 400 provides a multi-layer substrate that may mimic the thickness and rigidity of plastic gift cards while utilizing paper-based materials.

As further shown in FIG. 4, the PVC gift card 450 includes a gift card front 460 that serves as a printing area for customization. The gift card front 460 provides a surface for receiving custom printed images, text, logos, or other visual content through the dye-sublimation thermal transfer printing process. A gift card back 470 is positioned on an opposite side of the PVC gift card 450 from the gift card front 460. The gift card back 470 provides an optional printing area that may receive additional printed content.

The PVC gift card 450 includes a magstripe 480 positioned on the gift card back 470. The magstripe 480 may be a 3-track magnetic stripe configured to store encoded data for gift card activation and transaction processing. The magstripe 480 may be positioned horizontally across an upper portion of the gift card back 470. An NFC chip 490 may be provided on the PVC gift card 450 as an alternative to the magstripe 480. The NFC chip 490 enables contactless communication for gift card activation and redemption. In some cases, the PVC gift card 450 may include the magstripe 480 without the NFC chip 490, or the PVC gift card 450 may include the NFC chip 490 without the magstripe 480.

The PVC gift card 450 may have a CR80 size of 2.13 inches by 3.38 inches (54 mm×86 mm). The PVC gift card 450 may have a thickness of approximately 30 mil (about 0.03 inches). The CR80 size and 30 mil thickness of the PVC gift card 450 conform to industry standard dimensions for gift cards and credit cards, enabling the PVC gift card 450 to be carried in a wallet or card holder.

Both the paper gift card 400 and the PVC gift card 450 may be configured to receive custom printing on the gift card front 410, 460 and optionally on the gift card back 420, 470. The magstripe 430, 480 or the NFC chip 440, 490 on the paper gift card 400 and the PVC gift card 450 may be encoded with gift card activation data including unique gift card numbers and personal identification numbers (PINs) for on-demand activation through kiosk-based printing systems as disclosed herein.

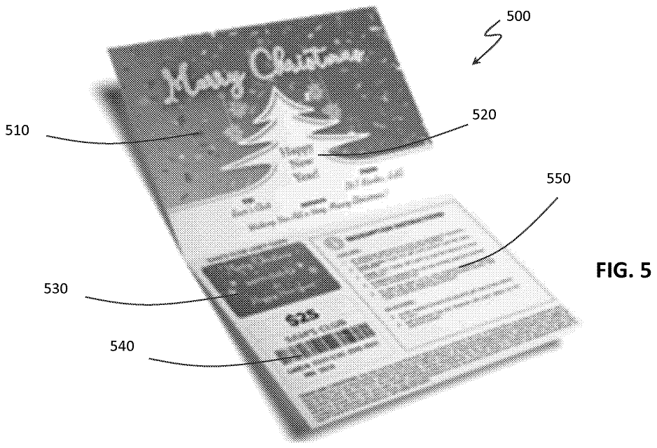

Referring to FIG. 5, a custom printed greeting card 500 is illustrated with an integrated gift card 530. The custom printed greeting card 500 is shown in a partially folded configuration, displaying both a greeting card portion and an attached gift card portion. The custom printed greeting card 500 may be printed on laminated paper stock similar to the greeting card stock 110 and the greeting card stock 210 described with reference to FIGS. 1 and 2.

The custom printed greeting card 500 includes an image printing area 510 positioned on an upper portion of the custom printed greeting card 500. The image printing area 510 displays custom printed visual content, which in the illustrated embodiment includes a festive holiday design. The image printing area 510 may receive custom printed images, graphics, text, or other visual content through the dye-sublimation thermal transfer printing process. The dye-sublimation thermal transfer process employs heat to vaporize ink from a ribbon so that the ink penetrates and fuses into the substrate at the molecular level. A thermal printhead applies heat to a ribbon, vaporizing the ink so that the ink penetrates the laminated paper stock surface. The vaporized ink transitions from a solid state to a gas state, diffuses under the surface of the laminated paper stock, and returns to a solid state. The printed image is infused under the acrylic, PVC, polyester or other polymer coating of the laminated paper stock to prevent smudging or smearing.

With continued reference to FIG. 5, a personalized message 520 is located below the image printing area 510 on the custom printed greeting card 500. The personalized message 520 may include customized text such as recipient information, sender information, and greeting text. The personalized message 520 may be printed through the dye-sublimation thermal transfer process such that the text is infused under the polymer coating of the laminated paper stock.

The integrated gift card 530 is positioned on a lower portion of the custom printed greeting card 500. The integrated gift card 530 may feature a coordinated design with the image printing area 510 and may include a monetary value indication. The integrated gift card 530 may be surrounded by a perforated perimeter similar to the perforated perimeter 240 described with reference to FIG. 2, enabling the integrated gift card 530 to be separated from the custom printed greeting card 500 for independent use.

As further shown in FIG. 5, a bar code 540 is printed on the integrated gift card 530. The bar code 540 provides a scannable code for activation and redemption of a gift card value associated with the integrated gift card 530. The bar code 540 may be a quick response (QR) code for activation and transaction processing. The bar code 540 may be printed through the dye-sublimation thermal transfer process such that the bar code 540 is infused under the polymer coating of the laminated paper stock, providing resistance to smudging or smearing during handling and use. The bar code 540 may encode unique gift card activation data obtained from gift card issuers through communication over a secure network.

Instructions for redeeming gift card 550 are printed on the custom printed greeting card 500 adjacent to the integrated gift card 530. The instructions for redeeming gift card 550 provide a recipient with information on how to use the integrated gift card 530. The instructions for redeeming gift card 550 may include terms and conditions, redemption procedures, or other information related to the integrated gift card 530. The custom printed greeting card 500 demonstrates the combination of a personalized greeting card with an integrated and activated gift card printed on a single piece of laminated paper stock.

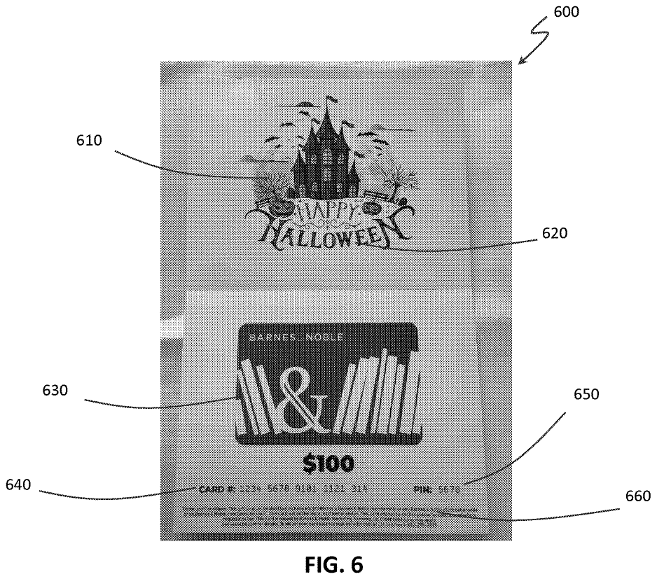

Referring to FIG. 6, a custom printed greeting card 600 is illustrated with an integrated gift card 630. The custom printed greeting card 600 demonstrates an alternative gift card activation approach compared to the bar code-based activation described with reference to FIG. 5. The custom printed greeting card 600 may be printed on laminated paper stock similar to the greeting card stock 110 and the greeting card stock 210 described with reference to FIGS. 1 and 2.

The custom printed greeting card 600 includes an image printing area 610 positioned in an upper portion of the custom printed greeting card 600. The image printing area 610 displays custom printed visual content, which in the illustrated embodiment includes a Halloween-themed illustration. The image printing area 610 may receive custom printed images, graphics, text, or other visual content through the dye-sublimation thermal transfer printing process. A personalized message 620 is associated with the image printing area 610 on the custom printed greeting card 600. The personalized message 620 may include customized text such as recipient information, sender information, and greeting text.

With continued reference to FIG. 6, the integrated gift card 630 is positioned in a lower portion of the custom printed greeting card 600. The integrated gift card 630 may feature a branded design and a denomination indication. The integrated gift card 630 may be surrounded by a perforated perimeter similar to the perforated perimeter 240 described with reference to FIG. 2, enabling the integrated gift card 630 to be separated from the custom printed greeting card 600 for independent use.

The integrated gift card 630 includes a generated gift card number 640 displayed as a card number sequence on the integrated gift card 630. The generated gift card number 640 provides a unique identifier for the integrated gift card 630 that enables activation and redemption of a gift card value. A generated gift card PIN 650 is shown adjacent to the generated gift card number 640 on the integrated gift card 630. The generated gift card PIN 650 provides a personal identification number that may be used in conjunction with the generated gift card number 640 for gift card redemption and transaction processing.

As further shown in FIG. 6, instructions for redeeming gift card 660 are provided below the generated gift card number 640 and the generated gift card PIN 650 on the custom printed greeting card 600. The instructions for redeeming gift card 660 provide information regarding terms and conditions for using the integrated gift card 630. The instructions for redeeming gift card 660 may include redemption procedures, usage restrictions, or other information related to the integrated gift card 630.

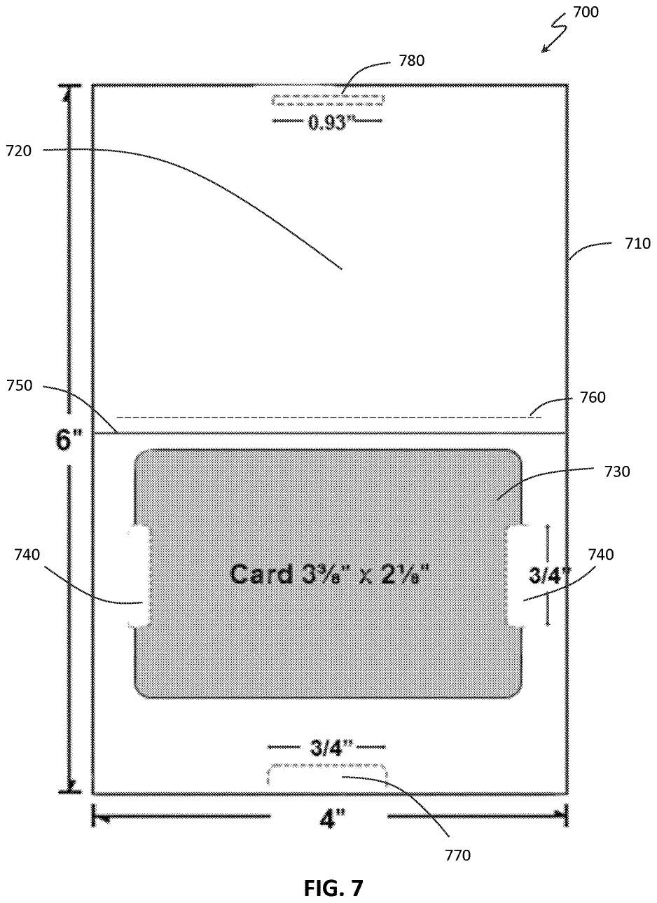

Referring to FIG. 7, a customizable greeting card 700 is configured to hold an integrated paper gift card 730. The customizable greeting card 700 is formed from a greeting card stock 710, which comprises laminated paper stock. The greeting card stock 710 may have dimensions of approximately 4 inches in width and 6 inches in height. The customizable greeting card 700 includes a greeting card print area 720 positioned in an upper portion of the greeting card stock 710. The greeting card print area 720 provides a surface for receiving custom printed images, text, or other visual content through the dye-sublimation thermal transfer printing process.

A slot 780 is formed proximate the top edge of the greeting card stock 710. The slot 780 is configured to receive a tongue tab 770 when the customizable greeting card 700 is folded. A fold line 750 extends horizontally across the greeting card stock 710, dividing the customizable greeting card 700 into upper and lower portions. A perforated line 760 is positioned adjacent to the fold line 750. The perforated line 760 may be micro-perforated or scored to facilitate separation between the greeting card portion and the gift card portion.

The lower portion of the customizable greeting card 700 accommodates the integrated paper gift card 730. The integrated paper gift card 730 may have dimensions of approximately 3⅜ inches by 2⅛ inches and may feature rounded corners. Gift card flaps 740 are positioned at the corners of the integrated paper gift card 730. The gift card flaps 740 are configured to secure the integrated paper gift card 730 within the customizable greeting card 700. The tongue tab 770 is formed proximate the bottom edge of the customizable greeting card 700. The tongue tab 770 is designed to engage with the slot 780 when the customizable greeting card 700 is folded along the fold line 750, providing a closure mechanism that holds the greeting card in a folded position.

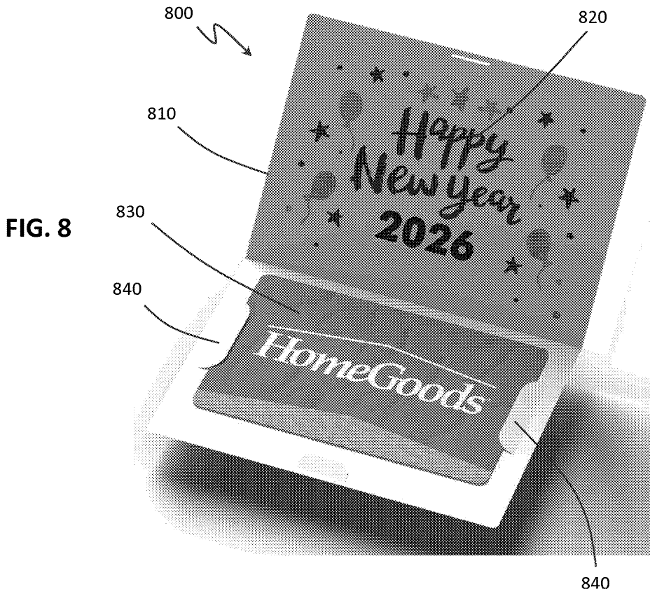

Referring to FIG. 8, a custom printed greeting card 800 is configured to hold a PVC gift card 830. The custom printed greeting card 800 is shown in a partially open configuration, displaying both the greeting card portion and the gift card holding area. The custom printed greeting card 800 includes a greeting card print area 810 positioned on an upper portion of the card. The greeting card print area 810 displays a greeting card customized image 820, which may include festive designs, decorative elements, and customized text. The greeting card customized image 820 is printed through the dye-sublimation thermal transfer process.

The lower portion of the custom printed greeting card 800 accommodates the PVC gift card 830. The PVC gift card 830 is secured within the custom printed greeting card 800 by gift card holder flaps 840 positioned on opposing sides of the gift card receiving area. The gift card holder flaps 840 extend over the edges of the PVC gift card 830 to retain the card in position within the folded greeting card structure. The custom printed greeting card 800 demonstrates the combination of a personalized greeting card with a separate PVC gift card held within the greeting card structure.

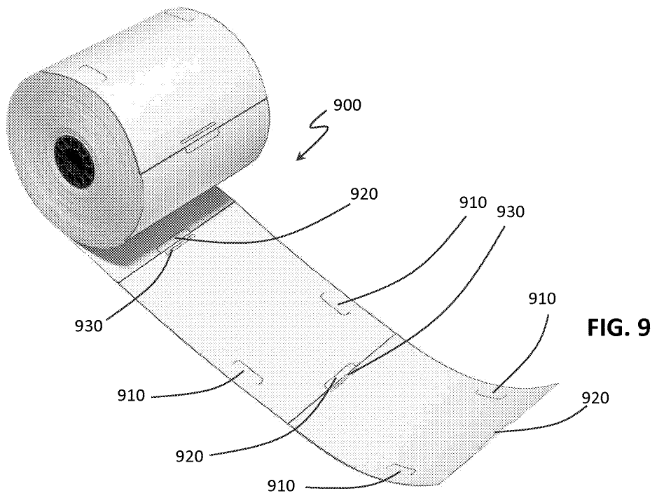

Referring to FIG. 9, a greeting card paper stock roll 900 comprises a roll of laminated paper stock configured for use in on-demand printing of customized greeting cards and gift cards. The greeting card paper stock roll 900 provides the greeting card stock in a roll stock paper format, which may facilitate efficient feeding of the laminated paper stock through kiosk-based printing systems. The laminated paper stock of the greeting card paper stock roll 900 may comprise a white paper core with a polymer gloss coating formed over the white paper core.

The greeting card paper stock roll 900 includes die-cut features that are pre-formed into the laminated paper stock. Flaps 910 are formed on the paper stock, with multiple instances visible on the unrolled portion of the paper. The flaps 910 are positioned along the lateral edges of the laminated paper stock and are configured to function as gift card holder flaps for receiving and securing a physical gift card, such as a PVC gift card, within a printed greeting card. A tongue 920 is formed on the paper stock, appearing as a semi-circular flap positioned on the laminated paper. The tongue 920 is designed to be perforated into the paper and functions as part of a fold and lock closure system. A tongue slot 930 is formed on the paper stock and is configured to receive the tongue 920 when the printed greeting card is folded along its middle, thereby holding the greeting card in a folded position.

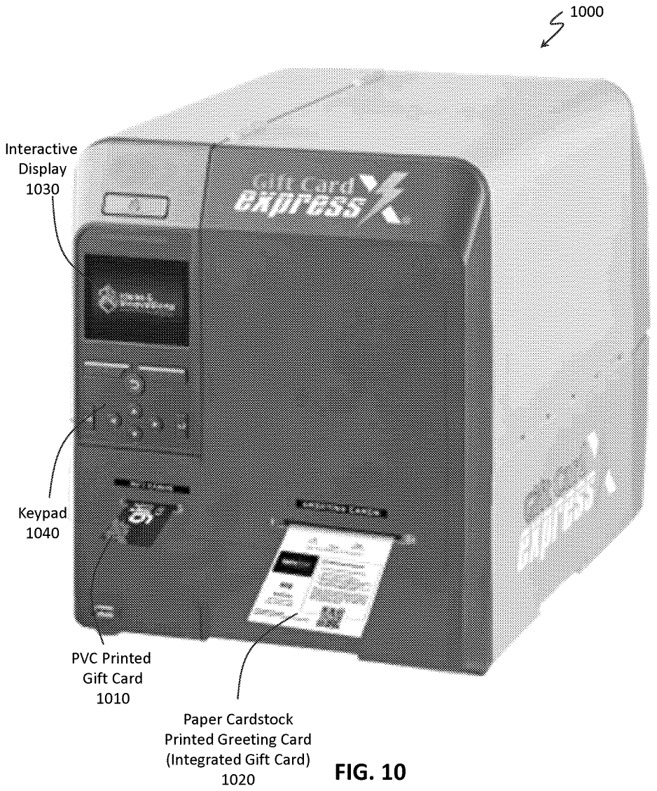

Referring to FIG. 10, an all-in-one printer 1000 is configured to print customized greeting cards and gift cards. The all-in-one printer 1000 is a stand-alone dye sublimation printer designed to produce both paper cardstock printed greeting cards and PVC printed gift cards on demand. The all-in-one printer 1000 may comprise a unified thermal transfer printing engine configured to selectively deposit pigment onto a plurality of disparate substrates, including a first paper-based greeting card substrate and a second CR80-compliant PVC substrate, within a single user session.

The all-in-one printer 1000 includes an interactive display 1030 positioned on the front upper portion of the printer housing. The interactive display 1030 provides a user interface for operating the printer and may display status information, printing options, or other operational data. Below the interactive display 1030, a keypad 1040 is positioned on the front face of the all-in-one printer 1000. The keypad 1040 includes multiple buttons that enable user input for controlling printer functions and navigating menu options.

The all-in-one printer 1000 features output areas from which printed products are dispensed. A PVC printed gift card 1010 is shown emerging from a lower output slot on the front of the all-in-one printer 1000. The PVC printed gift card 1010 demonstrates the capability of the all-in-one printer 1000 to produce customized gift cards on PVC gift card blanks using the dye-sublimation thermal transfer process. A paper cardstock printed greeting card 1020 is shown emerging from an adjacent output area. The paper cardstock printed greeting card 1020 demonstrates the capability of the all-in-one printer 1000 to produce customized greeting cards with integrated gift cards on paper card stock. The all-in-one printer 1000 is configured to perform dye-sublimation thermal transfer printing on both laminated paper stock for greeting cards with integrated gift cards and on PVC gift card blanks for separate gift cards, providing duplex printing capability within a single printer unit.

The all-in-one printer 1000 may utilize a common thermal print head to interface with both porous substrates such as paper and greeting card stock and non-porous substrates such as PVC and CR80 materials. The multi-substrate path capability enables a single printing system to accommodate different substrate materials without requiring separate printing equipment for each substrate type. The all-in-one printer 1000 may produce customized greeting cards and gift cards in approximately 8.3 seconds, including gift card activation for both physical and digital deliverables on demand.

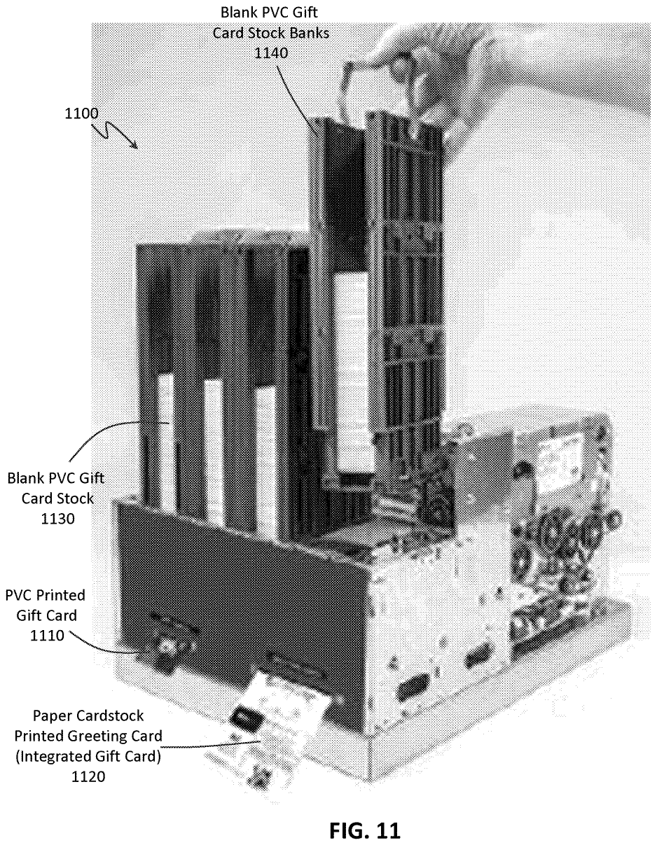

Referring to FIG. 11, an all-in-one printer 1100 is illustrated showing internal components. The all-in-one printer 1100 is configured to print customized greeting cards and gift cards using a dye sublimation printing process. The all-in-one printer 1100 includes blank PVC gift card stock bank holders 1140 positioned in an upper portion of the printer. The blank PVC gift card stock bank holders 1140 comprise multiple vertical card holding structures arranged in a row, each configured to hold a stack of blank PVC gift cards.

Blank PVC gift card stock blanks 1130 are visible within the card holding structures, shown as stacks of cards positioned within the vertical bank holders. The blank PVC gift card stock blanks 1130 provide the substrate material for printing customized gift cards through the dye sublimation thermal transfer process. Blank PVC gift card stock 1120 is contained within the blank PVC gift card stock bank holders 1140, representing the inventory of unprinted gift card blanks available for customization and activation. A PVC printed gift card 1110 is shown in a lower portion of the all-in-one printer 1100, positioned at an output location. The PVC printed gift card 1110 represents a completed customized gift card that has been printed and is ready for dispensing from the printer. In accordance with the disclosed principles, both the paper cardstock greeting card and the PVC gift cards are printed with the same printer and printing head via the unique dye sublimation techniques disclosed herein.

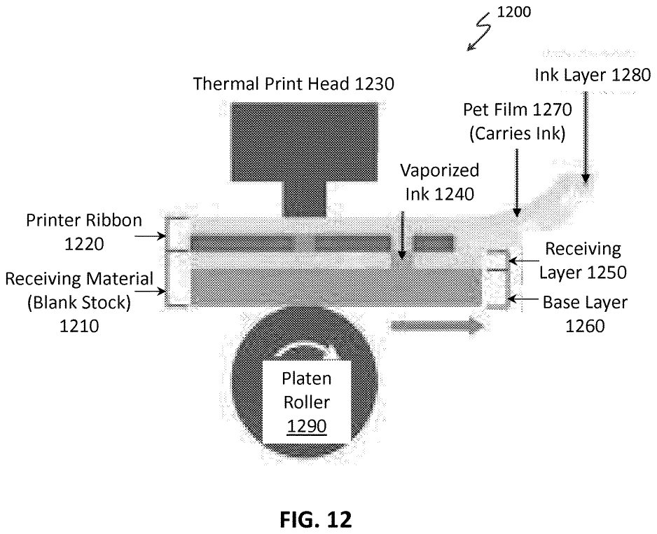

Referring to FIG. 12, a dye sublimation printing process 1200 is illustrated showing the interaction between printing components and substrate materials during thermal transfer printing operations. The dye-sublimation thermal transfer process works by using heat to turn solid pigments into a gas, which then permeates the surface of a polymer-coated substrate or polyester materials.

The dye sublimation printing process 1200 includes a thermal print head 1230 positioned above the substrate materials. The thermal print head 1230 applies heat to initiate the dye sublimation process. A printer ribbon 1220 is positioned between the thermal print head 1230 and the receiving material 1210. The printer ribbon 1220 contains panels of cyan, magenta, yellow, and black, and optionally a clear overcoat (CMYO). As the thermal print head 1230 heats up, the dyes sublimate, skipping the liquid phase, and bond directly with the polyester fibers or polymer coating on paper or coated plastic.

The receiving material 1210, also referred to as blank stock, is positioned below the printer ribbon 1220. The receiving material 1210 serves as the substrate onto which the vaporized ink is transferred. A platen roller 1290 is positioned beneath the receiving material 1210 and provides support and pressure during the printing operation. The platen roller 1290 rotates to advance the receiving material 1210 through the printing zone.

During operation, the thermal print head 1230 applies heat to the printer ribbon 1220, causing vaporized ink 1240 to be released. The vaporized ink 1240 transitions directly from a solid state to a gaseous state and penetrates the surface of the receiving material 1210. Once the heat is removed, the dye returns to a solid state, becoming a permanent part of the material substrate rather than sitting on top of it like traditional resin or inkjet printing.

The substrate structure comprises multiple layers including a base layer 1260, a receiving layer 1250 positioned above the base layer 1260, a pet film 1270 that carries ink, and an ink layer 1280 positioned on the pet film 1270. The pet film 1270 functions as a carrier for the ink during the sublimation process. The receiving layer 1250 receives the vaporized ink 1240, which diffuses into the substrate and returns to a solid state, becoming an integral part of the material rather than remaining on the surface.

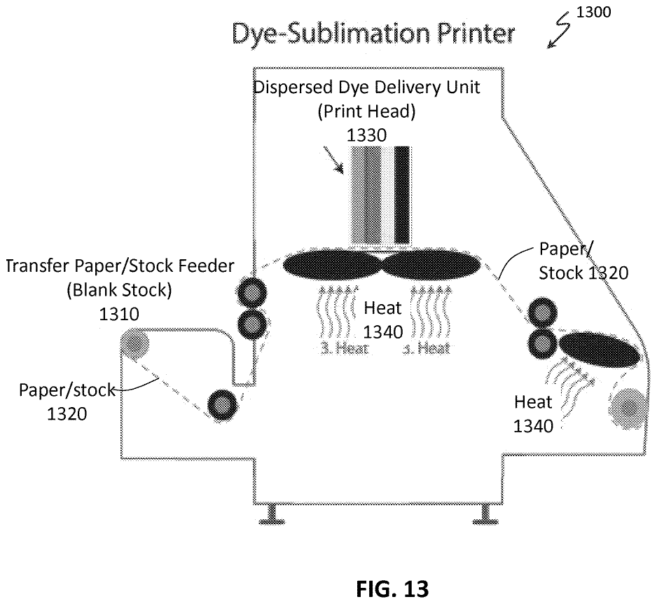

Referring to FIG. 13, a dye-sublimation printer 1300 is illustrated during a dye-sublimation printing process. The dye-sublimation printer 1300 includes a transfer paper/stock feeder 1310 positioned on one side of the system, which is configured to supply blank stock to the printing process. Paper/stock 1320 is fed from the transfer paper/stock feeder 1310 and travels through the dye-sublimation printer 1300 along a path through multiple rollers that guide the material through the printing process.

A dispersed dye delivery unit 1330, also referred to as a print head, is positioned in an upper central portion of the dye-sublimation printer 1300. The dispersed dye delivery unit 1330 includes multiple color panels shown as cyan, magenta, yellow, and black sections, which correspond to the dye colors used in the dye-sublimation thermal transfer process. Heat 1340 is applied at multiple locations within the dye-sublimation printer 1300. Heat 1340 is applied beneath the dispersed dye delivery unit 1330 to vaporize the dye from the ribbon so that the dye penetrates the paper/stock 1320. Additional heat 1340 may be applied as the paper/stock 1320 exits the printing area.

The dye-sublimation printer 1300 may utilize a common thermal print head to interface with both porous substrates such as paper and greeting card stock and non-porous substrates such as PVC and CR80 materials. The print head adapts with precision ink placement to produce clear, high-quality images by depositing dye onto the substrate with extreme accuracy, demanding high precision with mechanical and electronic components coordination. The dye-sublimation printer 1300 may include cooling systems configured to effectively dissipate heat generated by the print head to prevent bonding issues or degradation of print quality.

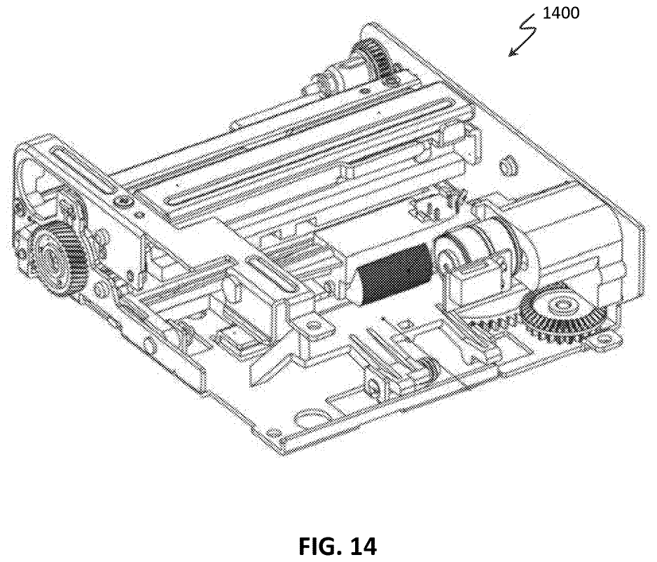

Referring to FIG. 14, a dye sublimation printer 1400 is illustrated as a wireframe model revealing internal mechanical components and structural arrangement of the printer assembly. The dye sublimation printer 1400 includes a chassis or frame structure that houses the various mechanical components. Visible within the dye sublimation printer 1400 are gear mechanisms positioned at opposing corners of the assembly, which facilitate the movement of paper stock or card stock through the printing mechanism.

The dye sublimation printer 1400 includes cylindrical roller components that function as part of the media transport system for feeding laminated paper stock or PVC gift card blanks through the printing path. A motor assembly is positioned within the dye sublimation printer 1400 and provides the driving force for the gear mechanisms and roller components. A central region of the dye sublimation printer 1400 contains a thermal print head assembly area, which applies heat to a ribbon to vaporize ink during the dye-sublimation thermal transfer process. The dye sublimation printer 1400 includes guide rails and support structures that maintain alignment of the substrate material during printing operations.

In accordance with the disclosed principles, the dye sublimation printer 1400 may be configured as a single printer for printing both CR80 paper cards and PVC cards using the same dye sublimation process. The single printer configuration may apply the same acrylic, PVC, polyester or other polymer coatings and dye sublimation process to both paper-based and PVC-based substrates, enabling production of both greeting cards and gift cards (paper or PVC) from a single printing unit.

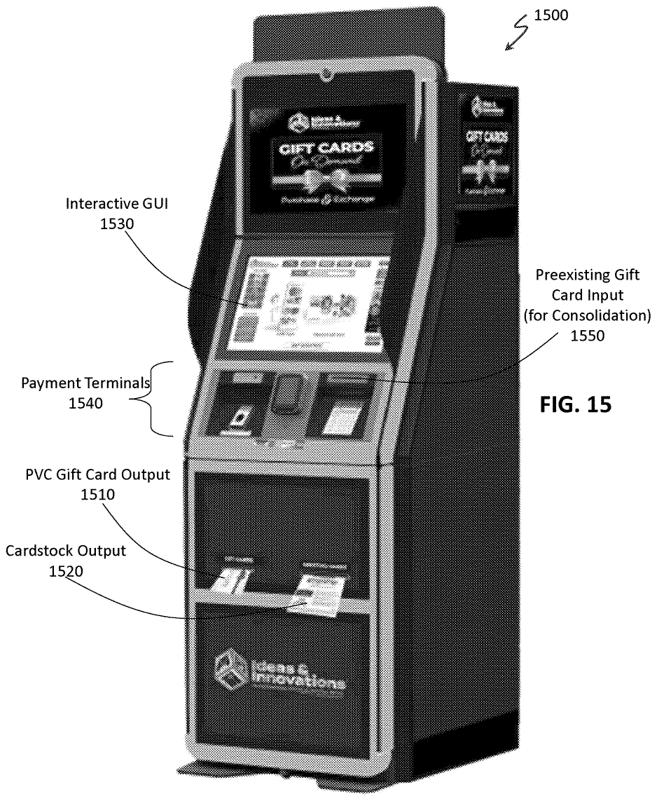

Referring to FIG. 15, a kiosk 1500 is configured for greeting card and gift card operations. The kiosk 1500 comprises a freestanding unit with multiple functional components arranged on its front-facing surface. The kiosk 1500 includes an interactive GUI 1530 positioned in an upper portion of the unit. The interactive GUI 1530 comprises a display screen showing gift card branding and promotional content with options for purchase and exchange functionality.

Payment terminals 1540 are positioned below the touchscreen display area. The payment terminals 1540 include card readers and payment processing devices configured to accept various payment methods for gift card purchases. A preexisting gift card input 1550 is located on the kiosk 1500 adjacent to the payment terminals 1540. The preexisting gift card input 1550 is configured for consolidation operations, enabling users to input existing gift cards for balance transfer or consolidation purposes.

The lower portion of the kiosk 1500 includes output areas for printed products. A PVC gift card output 1510 is positioned to dispense printed and activated PVC gift cards. A cardstock output 1520 is positioned adjacent to the PVC gift card output 1510 and is configured to dispense printed greeting cards on cardstock material. The kiosk 1500 integrates dye sublimation printing capabilities to produce customized greeting cards and gift cards on demand while providing real-time gift card activation through communication with gift card issuers over a secure network.

The kiosk 1500 may include automatic laminating technology that provides water resistant, dustproof, and oxidation-resistant protection for printed greeting cards and gift cards. The automatic laminating technology may eliminate the need for traditional plastic sealing while ensuring that printed images and text on greeting cards and gift cards resist fading during handling and extended use.

Kiosk-based printing systems as disclosed herein may employ proprietary software that enables on-demand activation of gift cards through communication over a secure network with gift card issuers. The gift card activation process obtains unique gift card numbers and personal identification numbers (PINs) from gift card issuers. The obtained gift card numbers and PINs are encoded onto the customized gift cards to activate the gift cards. In the embodiment illustrated in FIG. 6, the generated gift card number 640 and the generated gift card PIN 650 are printed on the integrated gift card 630 along with the instructions for redeeming gift card 660. The printed generated gift card number 640 and the generated gift card PIN 650 enable on-demand activation and redemption of the integrated gift card 630 without requiring pre-activated card inventory. The custom printed greeting card 600 demonstrates the combination of a customized greeting card with an activated gift card printed on laminated paper stock, where the gift card information including the generated gift card number 640 and the generated gift card PIN 650 enables on-demand activation and redemption of the integrated gift card 630.

Kiosk-based printing systems in accordance with the disclosed principles may provide duplex printing capability for both laminated paper stock and PVC gift card blanks. The duplex printing capability enables a single printing system to accommodate different substrate materials, including the laminated paper stock used for greeting cards and the rigid PVC material used for gift card blanks. The printing system may switch between substrate types to produce customized greeting cards on laminated paper stock and customized gift cards on PVC blanks within a single kiosk installation.

The printing system may provide full color or black and white printing on both a frontside and a backside of the paper stock or card stock. In some cases, the printing system may print full color on one of the frontside or the backside and black and white on the other of the frontside or the backside. The dual-side printing capability enables customization of both surfaces of greeting cards and gift cards, allowing for printed images, text, and graphics on a front surface and additional content such as terms, conditions, or decorative elements on a back surface.

The printing system may print customized greeting cards, customized gift cards, or both integrated in a single paper stock in about 15 seconds print speed. The 15 second print speed enables on-demand production of customized greeting cards and gift cards at a rate suitable for retail kiosk applications where customers may be waiting for printed products.

Ribbon cartridges included with the printing system may have a capacity of 500 prints of 4 inch by 6 inch size or more. The ribbon cartridge capacity enables extended operation of the printing system between ribbon replacements, reducing maintenance requirements for kiosk installations.

Blank PVC gift cards may be held in a card holder called a hopper. The hopper may hold a 2,000 total blank card capacity. The 2,000 card capacity of the hopper enables extended operation of the printing system for gift card production without requiring frequent replenishment of blank card stock.

The laminated paper stock and PVC gift card substrates may include a clear acrylic, PVC, polyester or other polymer overcoat layer. The clear polymer overcoat layer protects against fingerprints and ultraviolet (UV) fading. The protective overcoat layer preserves the appearance of printed images and text on greeting cards and gift cards during handling and extended use.

The laminated paper stock may comprise a white paper core with a clear acrylic, PVC, polyester or other polymer gloss coating formed over the white paper core. The white paper core permits printing of any type of writing or image on the laminated paper stock while maintaining true colors. The white paper core provides a neutral base that does not alter the color appearance of printed images, enabling accurate color reproduction through the dye-sublimation thermal transfer printing process.

The printing system may be configured to activate gift cards by writing or encoding data onto blank magstripes or blank NFC chips formed in gift card blanks. The magstripe encoding capability enables the printing system to write activation data to 3-track magnetic stripes on gift card blanks. The NFC chip encoding capability enables the printing system to write activation data to near-field communication chips on gift card blanks. The encoding capabilities enable on-demand activation of gift cards at the point of sale by writing unique gift card numbers and personal identification numbers obtained from gift card issuers through communication over a secure network. The magstripe and NFC chip encoding capabilities complement the printed activation methods such as bar codes, QR codes, and alphanumeric codes described herein, providing multiple options for gift card activation depending on the type of gift card blank employed.

Kiosk-based printing systems in accordance with the disclosed principles provide advantages over conventional greeting card and gift card production methods. Conventional mass production of greeting cards employs sheet-fed offset lithography, which utilizes the principle that oil and water do not mix to transfer ink from metal plates to a rubber blanket and onto paper. While offset lithography may be suitable for high-volume production runs, offset lithography may not be well-suited for on-demand customization applications where individual cards are printed in real time based on customer selections. The setup requirements and plate preparation associated with offset lithography may make single-card or small-batch production impractical for retail kiosk environments.

The dye-sublimation thermal transfer process employed by kiosk-based printing systems as disclosed herein may overcome limitations associated with conventional printing techniques for on-demand applications. Conventional digital printing methods, including inkjet and laser technologies, deposit ink on the surface of the substrate material. Surface-deposited ink may be susceptible to smudging, smearing, or scratching during handling. The dye-sublimation thermal transfer process infuses ink into the substrate material rather than depositing ink on the surface. The vaporized ink penetrates under the surface of the polymer-coated laminated paper stock and returns to a solid state, becoming an integral part of the underlying paper stock material. The infused ink may resist cracking, peeling, or fading because the ink is fused into the substrate at the molecular level rather than adhered to the surface.

The polymer gloss coating on the laminated paper stock disclosed herein may provide additional protection compared to conventional greeting card materials. Conventional greeting cards may undergo secondary processes such as UV coating or lamination to protect printed surfaces. The polymer gloss coating on the laminated paper stock disclosed herein is pre-formed on the paper stock prior to printing, and the dye-sublimation process infuses ink under the polymer coating. The pre-formed polymer coating may eliminate the need for post-printing protective coating operations while providing resistance to fingerprints and UV fading.

Conventional printing systems for greeting cards and gift cards may be limited to a single substrate type. Greeting card printing systems may be configured for paper or cardstock substrates, while gift card printing systems may be configured for PVC or other plastic substrates. The different material properties of paper-based greeting cards and plastic-based gift cards may require separate printing equipment with different printing processes, ink formulations, and material handling mechanisms. Kiosk-based printing systems as disclosed herein may accommodate both laminated paper stock and PVC gift card blanks within a single printing system. The duplex printing capability enables a single kiosk installation to produce customized greeting cards on laminated paper stock and customized gift cards on PVC blanks without requiring separate printing equipment for each substrate type.

Conventional gift card production and distribution may involve pre-printed and pre-activated gift cards that are shipped to retail locations. Pre-printed gift cards may limit customization options to designs selected during the manufacturing process. Pre-activated gift cards may require inventory management and security measures to prevent theft or unauthorized use of activated cards. Kiosk-based printing systems as disclosed herein may produce customized gift cards on demand with real-time activation. The on-demand production capability enables customization of gift card designs based on customer selections at the point of sale. The real-time activation capability eliminates the need for pre-activated card inventory by obtaining unique gift card numbers and personal identification numbers from gift card issuers through communication over a secure network at the time of purchase.

The combination of greeting card and gift card production in a single kiosk-based system may provide capabilities not offered by conventional systems. Conventional systems may require separate processes for greeting card production and gift card production, with gift cards being inserted into greeting cards as a separate assembly step. Kiosk-based printing systems as disclosed herein may produce combined greeting cards with integrated gift cards on a single piece of laminated paper stock. The integrated production capability may reduce assembly steps and enable coordinated designs between the greeting card portion and the gift card portion.

The encoding capabilities of kiosk-based printing systems as disclosed herein may provide flexibility in gift card activation methods. Conventional gift card activation may rely on a single activation method such as magnetic stripe encoding or bar code scanning. Kiosk-based printing systems as disclosed herein may activate gift cards through multiple methods, including printing bar codes, QR codes, or alphanumeric codes onto gift card surfaces, or writing data to magnetic stripes or NFC chips on gift card blanks. The multiple activation methods enable compatibility with different gift card issuer systems and different gift card blank configurations.

A number of implementations have been described. Nevertheless, it will be understood that various modifications may be made without departing from the spirit and scope of the disclosure. Accordingly, other implementations are within the scope of any accompanying claims stemming from this disclosure.

While this disclosure has been particularly shown and described with reference to preferred embodiments, it will be understood by those skilled in the pertinent field of art that various changes in form and detail may be made therein without departing from the spirit and scope of the disclosed principles. The inventors expect skilled artisans to employ such variations as appropriate, and the inventors intend the disclosed principles to be practiced otherwise than as specifically described herein. Accordingly, this disclosure includes all modifications and equivalents of the subject matter recited in the claims appended hereto, as permitted by applicable law. Moreover, any combination of the above-described elements in all possible variations thereof is encompassed by the disclosure unless otherwise indicated herein or otherwise clearly contradicted by context.

Also, while various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the disclosed principles set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” or disclosed principles in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

Moreover, the Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the claims reflect, inventive subject matter lies in less than all features of a single disclosed embodiment. Thus, the following claims are hereby incorporated into the Detailed Description, with each claim standing on its own as a separate embodiment.

Any and all publications, patents, and patent applications cited in this disclosure are herein incorporated by reference as if each were specifically and individually indicated to be incorporated by reference and set forth in its entirety herein.

1. A kiosk-based printing system, comprising:
a printer configured to perform a dye-sublimation thermal transfer process, wherein the printer is configured to print user-customized on-demand greeting cards on a laminated paper stock comprising a white paper core with a polymer gloss coating, and wherein the printer is further configured to print a user-customized on-demand gift card integrated with the greeting card on the laminated paper stock; and
a communication interface configured to communicate over a secure network with gift card issuers to obtain gift card activation data, wherein the kiosk-based printing system is configured to encode the gift card activation data onto the integrated gift card.

2. The kiosk-based printing system of claim 1, wherein the laminated paper stock is provided as roll stock, and wherein the kiosk-based printing system is configured to cut the greeting card from the roll.

3. The kiosk-based printing system of claim 1, wherein the laminated paper stock includes pre-formed die-cut features comprising gift card slots, tongue tabs, and slots for receiving the tongue tabs.

4. The kiosk-based printing system of claim 1, wherein the laminated paper stock includes micro-perforations around a perimeter of the integrated gift card.

5. The kiosk-based printing system of claim 1, wherein the laminated paper stock includes micro-perforations along a central lateral line of the greeting card for separating the greeting card from an area having the integrated gift card.

6. The kiosk-based printing system of claim 1, wherein encoding the gift card activation data onto the integrated gift card comprises printing a bar code on the gift card, wherein the bar code is generated based on receipt of the activation data.

7. The kiosk-based printing system of claim 1, wherein encoding the gift card activation data onto the integrated gift card comprises printing a unique gift card number and PIN on the gift card, wherein the gift card number and PIN are generated based on receipt of the activation data.

8. The kiosk-based printing system of claim 1, wherein the polymer gloss coating comprises polyester, acrylic, or PVC.

9. A kiosk-based printing system, comprising:
a printer configured to perform a dye-sublimation thermal transfer process, wherein the printer is configured to print user-customized on-demand greeting cards on a laminated paper stock comprising a white paper core with a polymer gloss coating, and wherein the printer is further configured to print user-customized on-demand gift cards on PVC gift card blanks having at least one data storage device;
a hopper configured to hold a plurality of blank PVC gift cards; and
a communication interface configured to communicate over a secure network with gift card issuers to obtain gift card activation data, wherein the kiosk-based printing system is configured to encode the gift card activation data onto the at least one data storage device.

10. The kiosk-based printing system of claim 9, wherein the laminated paper stock is provided as roll stock, and wherein the kiosk-based printing system is configured to cut the greeting card from the roll.

11. The kiosk-based printing system of claim 9, wherein the laminated paper stock includes pre-formed die-cut features comprising gift card slots, tongue tabs, and slots for receiving the tongue tabs.

12. The kiosk-based printing system of claim 9, wherein the at least one data storage device comprises a magnetic stripe or an NFC chip of a gift card blank.

13. The kiosk-based printing system of claim 12, wherein encoding the gift card activation data onto the gift card blank comprises encoding a unique gift card number and PIN on the magnetic stripe or NFC chip, wherein the gift card number and PIN are generated based on receipt of the activation data.

14. A method for on-demand printing and activation of customized greeting cards and gift cards in a kiosk system, comprising:
receiving user input specifying customization for a greeting card and for a gift card;
printing the customized greeting card on a laminated paper stock using a dye-sublimation thermal transfer process, wherein the dye-sublimation thermal transfer process comprises applying heat via a thermal printhead to a ribbon to vaporize ink, and wherein the vaporized ink penetrates the laminated paper stock surface and returns to a solid state to become an integral part of the laminated paper stock;
communicating over a secure network with a gift card issuer to obtain gift card activation data; and
encoding the gift card activation data onto the gift card.

15. The method of claim 14, wherein encoding the gift card activation data comprises printing at least one of a bar code or a QR code, representing a unique gift card number and PIN, on an integrated gift card portion of the laminated paper stock, wherein the gift card number and PIN are generated based on receipt of the activation data.

16. The method of claim 14, wherein encoding the gift card activation data further comprises printing a gift card number and a PIN on the integrated gift card portion of the laminated paper stock, wherein the gift card number and PIN are generated based on receipt of the activation data.

17. The method of claim 14, wherein encoding the gift card activation data comprises writing to at least one of a magnetic stripe or an NFC chip on a gift card blank the gift card activation data comprising a gift card number and PIN generated based on receipt of the activation data.

18. The method of claim 17, further comprising printing the customized gift card on a PVC gift card blank using the dye-sublimation thermal transfer process.

19. A laminated paper stock for on-demand printing of greeting cards and integrated gift cards, the stock comprising:
a white paper core; and
a polymer gloss coating formed over the white paper core, wherein the laminated paper stock is configured to receive dye-sublimation thermal transfer printing wherein dye is vaporized and infused into the white paper core under the polymer gloss coating.

20. The laminated paper stock of claim 19, wherein the laminated paper stock includes pre-formed die-cut features comprising:
a tongue tab formed as a semi-circular perforated flap proximate a bottom edge of the laminated paper stock; and
a slot formed proximate a top edge of the laminated paper stock configured to receive the tongue tab when the laminated paper stock is folded.

21. The laminated paper stock of claim 20, wherein the laminated paper stock further includes a perforated perimeter defining the integrated gift card and configured to be separated from a greeting card portion.
